(19) United States
(12) Patent Application Publication
(10) Pub. No.: US 2005/0018696 A1
(43) Pub. Date: Jan. 27, 2005

(54) Method for connecting a havi cluster and an ip cluster using a bridge device, and associated bridge device

(76) Inventor: Jean-Baptiste Henry, Melesse (FR)

Correspondence Address: Joseph S Tripoli;Thomson Licensing Inc, Patent Operations CN 5312, Princeton, NJ, 08543-0028, US

(21) Appl. No.: 10/496,271

(22) PCT Filed: Nov. 21, 2002
(86) PCT No.: PCT/EP02/13179

(30) Foreign Application Priority Data
Nov. 23, 2001 (EP) 01403018.3

(51) Int. Cl. H04L 12/28

(52) U.S. Cl. 370/401; 370/395.5; 370/489; 370/254

(57) ABSTRACT

Methods for connecting a HAVi cluster and an IP cluster using a bridge device. The first method is characterized in that comprises the steps of:—discovering an IP device on the IP cluster,—creating a HAVi device identifier (GUIDL) for the discovered device,—making the identifier available for reading by bridge aware HAVi software elements. The second method is characterized by the steps of:—discovering a HAVi device on the HAVi cluster,—creating an IP address for the discovered device,—making the IP address available for reading by bridge aware IP software elements. The invention also concerns a bridge device for implementing the methods.

The invention concerns a method for bridging two networks, such as a HAVi network and an IP based network (e.g. a UPnP network). It also concerns a bridge device.

Home networks need not be of homogeneous nature. Control of devices over device clusters based on different standards or exchange of content in such a case is difficult at best. For example, a mail with a picture attachment received on a UPnP cluster will not be visible from a HAVi cluster; and the user will not be able to print this picture on the HAVi printer.

Bridge devices may be used to connect two or more clusters. If the bridge device is transparent to devices on the clusters, the bridge has to make certain devices believe that some actions are carried out, although this may not be true. Establishment of a stream over the bridge may be such a case. A device may be led to believe that it established a stream with a device on the remote cluster, although it did not actually perform that action. A totally transparent bridge may thus not be desirable in all cases.

The present invention concerns a method for connecting a HAVi sub-network (cluster) and an IP sub-network (cluster) using an address or identifier proxy approach.

More specifically, the invention concerns a method for connecting a HAVi cluster and an IP cluster using a bridge device, characterized in that it comprises the steps of:
discovering an IP device on the IP cluster,
creating a HAVi device identifier (GUIDL) for the discovered device,
making the identifier available for reading by bridge aware HAVi software elements.

Thus a bridge aware device or software element on the HAVi cluster may access directly information relating to the devices on the IP network. This information can be used for example to establish streams in a certain manner.

According to an embodiment, the method further comprises the step of creating the HAVi device identifier comprises a step of determining whether the discovered IP device is adapted to provide resources to a HAVi device, and in creating the identifier only in the affirmative.

According to an embodiment, the IP device is a UPnP device, and the method further comprises the step of identifying UPnP services for the discovered UPnP device, and of providing, in the bridge device, a proxy HAVi device control module for the UPnP device and proxy HAVi functional component modules for the UPnP services, said modules being made available for communication with elements of the HAVi cluster.

According to an embodiment, the establishment of a stream connection between two devices initiated by an application on the HAVi cluster comprises the following steps:
calling of a Stream Manager by said application for requesting the establishment of the stream;
determination by the Stream Manager as to whether at least one of the two devices is on the IP cluster, and in the affirmative calling a software element of the bridge for establishing the connections for the stream set-up.

The bridge aware software element (e.g. a Stream Manager in a HAVi cluster) does not try to establish a connection itself if this connection involves a device belonging to another cluster. Instead, it verifies whether a, involved device is remote or not, and instructs another software element, in this case a software element of the bridge device to carry out this task

According to an embodiment, in the negative, the Stream Manager directly sets up the stream between two HAVi devices.

According to an embodiment, the method further comprises the step of assembling HAVi device identifiers for a plurality of discovered devices in an identifier list register.

According to an embodiment, the HAVi device identifier is a GUID identifier derived from an IP address of the discovered IP device.

The invention also concerns a bridge device for connecting a HAVi cluster to an IP cluster, characterized in that it comprises:
means for discovering IP devices on the IP cluster;
means for generating a list of device identifiers for the discovered IP devices, said list being readable by a bridge aware HAVi software element.

According to an embodiment, the bridge device further comprises the means for receiving a function call from a HAVi stream manager software element for establishment of a stream between two devices of which at least one is connected to the IP cluster.

Another object of the invention is a method for connecting a HAVi cluster and an IP cluster using a bridge device, characterized in that it comprises the steps of:
discovering a HAVi device on the HAVi cluster,
creating an IP address for the discovered device,
making the IP address available for reading by bridge aware IP software elements.

The characteristics of the invention can be applied in other environments than UPnP and HAVi (e.g. power line communication etc . . . ).

Other characteristics and advantages of the invention will appear through the description of a particular embodiment of the invention, explained with the help of the enclosed drawings, among which:

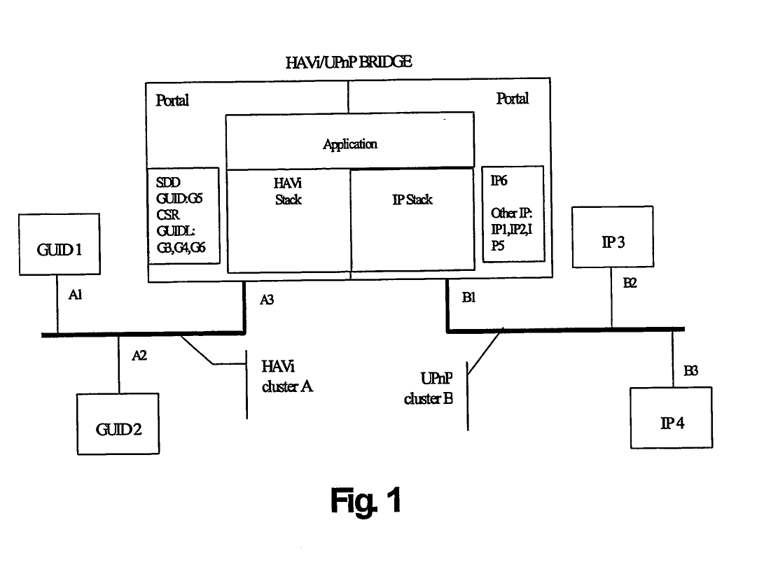

FIG. 1 is a diagram of a HAVi cluster and a UPnP cluster linked by a bridge and using a GUID/IP representation/proxy approach;

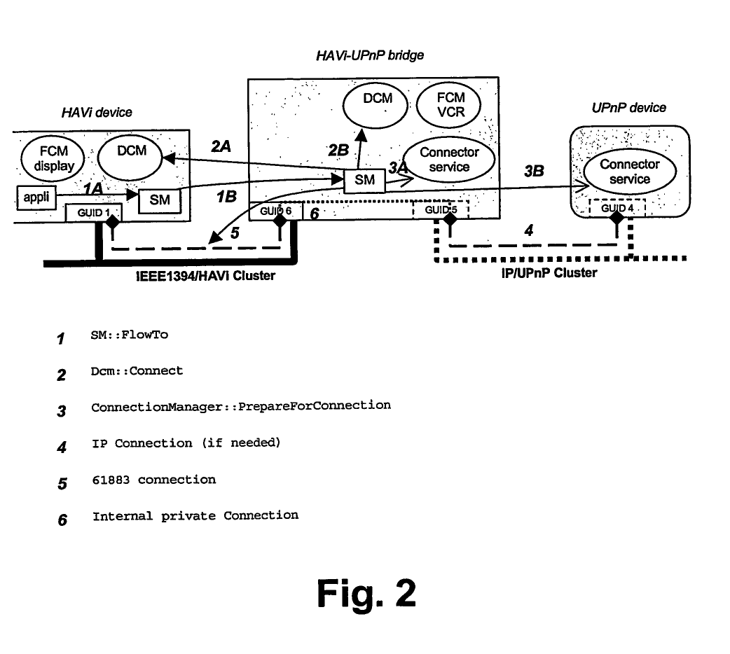

FIG. 2 is a diagram of a network comprising a HAVi sub-network and a UPnP sub-network linked by a bridge according to the embodiment, and indicating stream establishment steps;

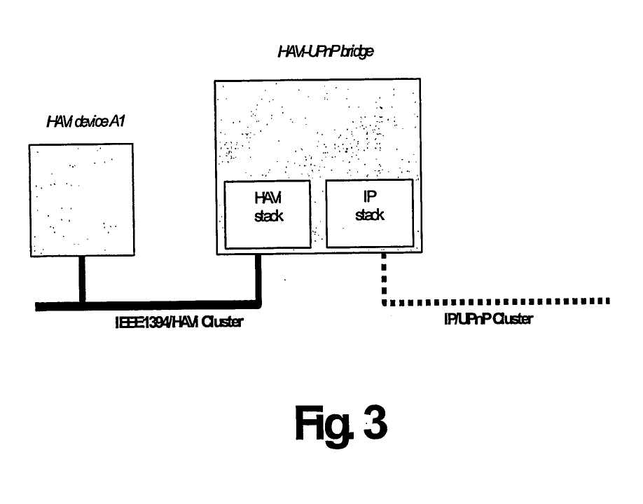

FIG. 3 is a diagram of a network comprising a HAVi sub-network and a bridge connected to an IP network to which no device is connected;

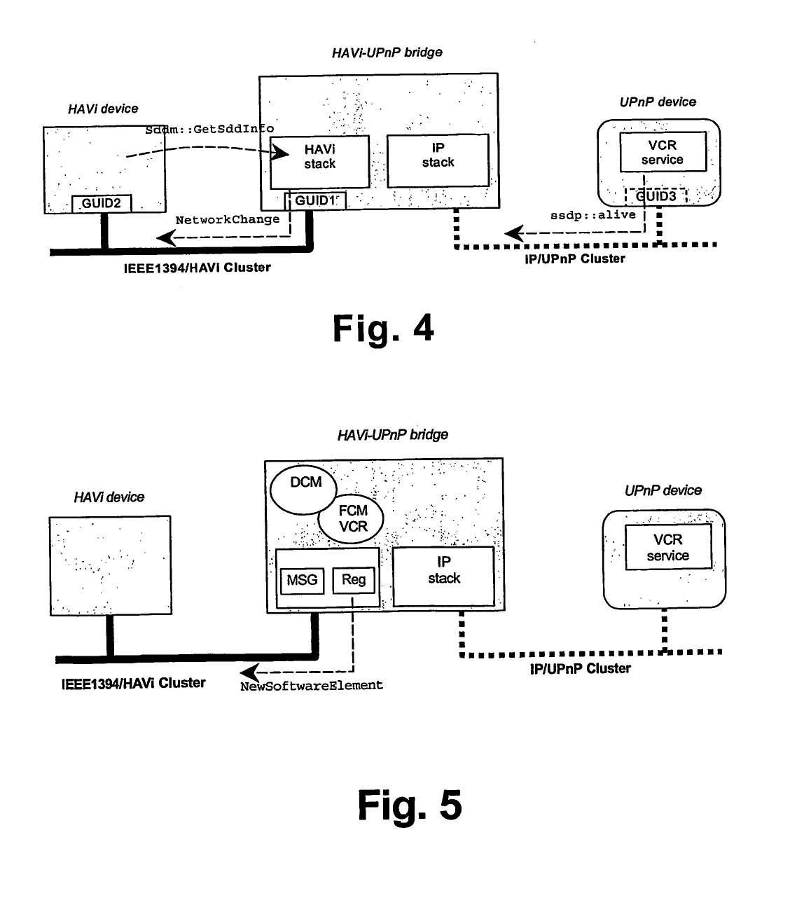

FIG. 4 is a diagram of the network of FIG. 3, where a UPnP device has been added to the IP network;

FIG. 5 is a diagram of the network of FIG. 4, where the UPnP device is proxied using a HAVi DCM and FCM;

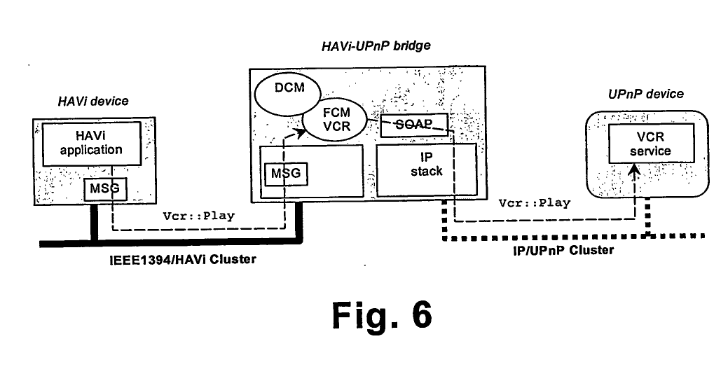

FIG. 6 is a diagram of the network of FIG. 5, illustrating the path of a command issued by a HAVi application to the UPnP device;

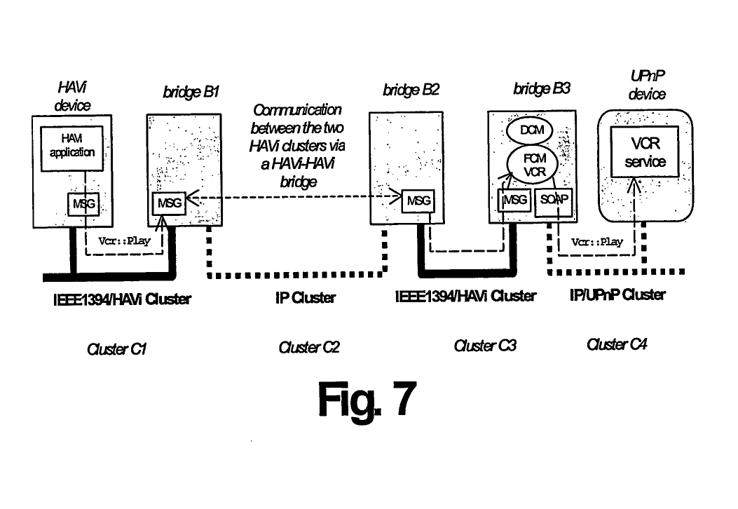

FIG. 7 diagram of a network with more than two sub-networks for illustrating bridge synchronization.

The present description is to be seen in conjunction with a European patent application filed on Nov. 23, 2001, in the name of Thomson Licensing SA, under the filing number 01403017.5 and having the title ‘Methods for establishing a connection between a first and a second device’. That application describes how HAVI and UPnP devices are represented by software objects of a bridge, and how streams are established over the bridge, or on one side of the bridge. This application describes a transparent bridge, and in particular how HAVi device control modules (DCMs) and functional component modules (FMCs) are represented by UPnP devices and services.

The present application concerns a complementary embodiment for a bridge device, based on the instantiation of device identifiers and addresses rather than on the instantiation of devices, functional components and services themselves. Streaming over a bridge is then made easier.

The bridge device represents on each cluster the devices of the other cluster. In particular, according to the present embodiment, the bridge maintains registers accessible respectively by the devices of the first cluster and the devices of the second cluster, in which certain information can be found concerning the devices on the remote cluster. In particular, on the HAVI side, a list of Global Unique Identifiers (‘GUID’ identifiers) of the remote devices is provided, for access by local devices. The registers containing these lists are called ‘GUIDL’ registers.

The CSR GUIDL register has the format given in table 1.

TABLE 1

| GUID | Exit portal GUID | Hops | Cluster type |
|---|---|---|---|
| 3 | 6 | 2 | type of cluster C |
| 4 | 6 | 2 | type of cluster C |
| 6 | 6 | 2 | type of cluster B |

The “Hops”-column contains the number of portals to cross before reaching the target. The “Cluster type” column points out the cluster link technology (IEEE 1394 for instance).

GUID identifiers are persistent and uniquely identify each IEEE 1394 device. Within a HAVi network, they constitute part of a further identifier, called SEID, which comprises the GUID identifier associated with a non-persistent handle. Moreover, each HAVi device maintains a correspondence table between the GUID identifier of a device and its IEEE 1394 physical identifier. For remote devices, the physical address will be that of the bridge which represents them.

Each time a bridge adds a new GUID identifier to a GUIDL register (in reaction to the connection of a device to the UPnP cluster), it transmits a me-sage on the HAVi cluster to announce the new device in the network. This announcement comprises the GUID of the new device.

When a new device is connected to the HAVi cluster, it has to read the GUIDL register of the bridges connected to its local cluster to determine which devices are remotely connected.

According to the present embodiment, GUID identifiers are used by the bridge to represent UPnP devices on the HAVi network side and IP addresses are used to represent HAVI devices on the UPnP network side.

As described above, when a new IEEE1394 device is connected to the HAVi network, the GUIDL register of the bridge is updated and a NetworkChanged event is sent to other clusters. For a UPnP cluster, an IP address is created for the HAVI device for mapping purposes. Similarly, when an IP device is connected, a GUID address is created in the bridge device. A NetworkChanged event is sent on the HAVi cluster to announce the appearance of the new device.

FIG. 1 is a schematic diagram of a HAVI cluster A and an UPnP cluster connected by a bridge. Each cluster comprises three devices (resp. A1-A3, B1-B3), the portals counting as a device on each cluster. The HAVi devices each possess a GUID, while the UPnP devices each possess an IP address. The portal on the HAVI side maintains a GUIDL list comprising GUID identifiers representing the UPnP devices B1 to B3. The corresponding GUIDs are G3, G4 and G6, where G6 represents the UPnP portal of the bridge. The HAVi portal's own GUID is G5. Similarly, the bridge maintains a list of identifiers of IEEE 1394 devices for the UPnP portal, this list comprising IP addresses IP1, IP2 and IP5, representing respectively devices A1, A2 and the HAVi portal.

According to the present embodiment, the bridge device first checks whether the devices it is supposed to proxy are of interest or not. Uninteresting device are e.g. devices which have no functionality to offer to applications (e.g. basic IP devices, routers etc . . . ). The bridge will not systematically create e.g. a GUID for each IP device of the IP cluster, but will first try to determine whether this is required.

When a UPnP device is connected to the IP cluster, the basic steps are :
(a) Discovery of the new IP node if possible, via DHCP or Auto-IP protocols
(b) SSDP messages and XML description downloading to discover the new UPnP node's capabilities/functionalities (e.g. the bridge receives a ssdp::alive message from the new device).
(c) If the UPnP device/service is deemed interesting, creation of a GUID for the UPnP device, within the GUIDL list of the portal on the HAVi side. The GUID can be built from the IP address, or from a MAC address. For example, if the IP address of the UPnP device is 169.254.100.16, its associated GUID could be FF FF FF FE A9 FE 64 10, where “A9 FE 64 10” is 169.254.100.16 in hexadecimal notation. The first three bytes (FF FF FF) represent for example the vendorID. This should ensure the uniqueness of the GUID on the multi-clustered network (no real GUID should start with FF FF FF). The 4th byte (FE) is the chipID high, as an example.

According to a variant, a conversion is made from the Ethernet address, or from the IPv6 address.

When a HAVi device is connected to the HAVi network, the steps are:
(a) Discovery of the IEEE 1394 devices, and of its DCMs (device control modules) and FCMs (functional component modules)
(b) Determination of an IP address for the bridge device (if such an address is not already available). This is done via known UPnP techniques (using AutoIP and DHCP). The UPnP devices and services corresponding to the discovered DCMs and FCMs are then created under the root UPnP device hosted by this single IP address.

According to a variant embodiment, the bridge assigns one IP address to each IEEE 1394 device, at least to those that are of interest. The bridge device will then host several IP addresses, each one being associated with a different root UPnP device.

The bridge device will simulate devices for the other side. It will intercept messages sent by a device from one side of the bridge to a device on the other side, typically forward the message and respond. As typically a HAVi application will try to read the SDD of a new IEEE 1394 device (in order to check whether the new device is a HAVi device or not, and which one), the bridge device has to be ready to answer those messages. A HAVi application reads the SDD data of a device across a bridge by calling the Sddm::GetSddInfo API of the last bridge device on the path.

The newly created GUID for proxied HAVi devices will have the minimal IEEE1394 configuration rom, i.e. it will not be associated with SDD (self describing device) data. This means that the instantiated devices are seen as LAV (Legacy Audio Video) devices as far as HAVi is concerned.

The bridge device then determines the HAVi DCM(s)/FCM(s) of a new HAVi device, and the new device(s)/service(s) of a new UPnP device, in order to build the DCM/FCM and the device/service proxies inside the bridge. The bridge then sends NewSoftwareElement messages or ssdp::alive messages on the HAVi, resp. the UPnP cluster, to announce the discovered objects.

The discovery is done on those events rather than on the GUID or IP address creation.

Concerning message translation, the principles are the same as those applied in the application relating to DCM/FCM instantiation cited at the beginning of the description of the present embodiment, with the difference that the GUID used in the SEID identifier for the DCMs or the FCMs is not the one of the bridge, but the one created for the UPnP device.

With the GUID/IP proxy technology, a stream crossing a bridge or bridge device is no more considered to be a local stream but a multi-clustered stream. The Stream Manager is not fooled by the bridge into believing that it established a local stream, instead of a multi-clustered stream. Indeed, according to the present embodiment, the Stream Manager (and eventually other software elements) is (resp. are) aware of the existence of a bridge, and of the fact that a device is on the local cluster or a remote cluster. The present embodiment requires an amendment of the HAVi specification in that the Stream Manager has to be bridge aware. The bridge is not totally transparent to all HAVi software elements. If a bridge aware device needs to discover a network, then it reads the CSR's GUIDL register information from all its bridges present within the cluster it is connected to. A bridge aware device identifies such portals by detecting a given identifier in the CSR register.

The stream establishment by a HAVi application is performed as follows, according to the present embodiment:

The HAVi application calls the FlowTo API of the Stream Manager of its device to set up a connection. The parameters of the FlowTo call are principally the FcmPlug structures of the source and sink. The FcmPlug is a structure comprising the TargetId of the FCM. The TargetId is a structure comprising the GUID of the target. In the case of the bridge FCM, it is the GUID created by the bridge for the UPnP device, and not the GUID of the bridge. The Stream Manager has to establish a stream between the HAVi device (GUID 1) and the UPnP device (created GUID 4). The Stream Manager knows that the device with GUID 4 is behind the bridge (since the GUID is provided in the GUIDL list), so it will call the FlowTo method of the Stream Manager of the bridge device (because this bridge device comprises the exit portal). It is the bridge's responsibility to create the stream, and the bridge device has all the data to do so.

The bridge first calls the Dcm::Connect API of the involved DCMs (the proxy DCM of the UPnP device involved in the connection is also called, to keep consistency in the state of the connections of the DCM, if two UPnP devices are involved, both DCMs are called). Then it will call the Connection Manager APIs on the UPnP side if needed (and if it exists). Finally, it makes the physical connections, IP on the UPnP side, IEC61883 on the HAVi side, and the internal one. This process is illustrated by FIG. 2.

An example of the connection of a new UPnP device/service will now be described. The diagram of FIG. 3 shows the initial network. There is no UPnP device on the UPnP network, and there is one HAVi device A1.

A new UPnP VCR device is then connected to the IP cluster (FIG. 4). The bridge device can detect this new device when it will be looking for a fresh IP address (via DHCP—Dynamic Host Configuration Protocol—or Auto-IP). The bridge device is notified of the new UPnP device and service via the SSDP protocol. The bridge then requests the UPnP description of this new device (written in XML) and discovers the device type and the service type (e.g. a VCR device with a VCR service).

A new GUID is then created by the bridge for this new IP device. The bridge device updates its GUIDL register and sends a NetworkChanged event on the HAVi side, to announce the connection of the new device. This will not generate a bus reset on the HAVi cluster.

HAVi devices will then want to read the SDD for this new GUID. They will send a SddManager::GetSddData message to the bridge device (which is seen as the last bridge before the new device). The bridge device will respond, giving a minimal IEEE 1394 configuration ROM. This new “1394 device” is then recognized as a legacy device (LAV), and the HAVi devices won't try to obtain more SDD data.

The bridge also creates a DCM and a VCR FCM on its HAVi side, to simulate the VCR device and VCR service of the UPnP cluster. These two software elements request a SEID from the Messaging System, and register themselves in the Registry of the bridge. This registration causes the Registry to send NewSoftwareElement events on the HAVi network, so all the HAVi applications are aware that two new software elements have arrived.

Creation and registration of the DCM and FCM is shown on FIG. 5. The DCM and FCM have the functionalities of their HAVi counterparts as far as the interface on the HAVi cluster is concerned. A user on the HAVi device wants to perform a playback on the new VCR device. This is performed using the user interface of the HAVI device to control the VCR and press the Play button (FIG. 6). The application send a PLAY command to the VCR FCM, and calls the FlowTo API of the Stream Manager of its HAVi device, which builds the stream, as specified above.

FIG. 7 is a diagram of a network comprising a chain of more than two clusters, in the present case two HAVi clusters C1 and C3 linked by an IP network C2, respectively through bridges B1 and B2. An IP/UPnP cluster N4 is connected to HAVi cluster 3 through a bridge B3.

The HAVi clusters communicate through a HAVi-HAVi bridge which is not the object of the present application.

The DCM/FCM VCR representing the UPnP VCR service have to be installed on bridge B3. The processes described above also apply in the case of chained clusters.

Nevertheless, the bridges have to be aware of each other, and the bridges have to synchronize for the creation of the proxies (i.e. they have to avoid creating proxies twice, and decide which bridge is to create which proxy).

In order to allow bridges to detect other bridges, on a network such as the one of FIG. 7, the following implementation is used
HAVi devices interacting on an IP/UPnP cluster
(a) Define a UPnP device type called ‘bridge’ or ‘gateway’ or ‘proxy’, with a string parameter to identify the cluster behind the bridge. For example, the string parameter can have the value “havi” or “1394”, with a “havi” extension. A UPnP bridge device will search for the other bridge device (via the well-known SSDP protocol) and check if they are connected to the same cluster. It builds a table with the IP addresses of the other bridge devices on the UPnP cluster. An IP tunneling process can be used to transfer HAVi messages between the two bridges via the IP network.
(b) Discover other HAVi devices within an IP network

According to the present embodiment, HAVi devices announce themselves on a specific multicast IP address. A HAVi device listens to this specific address to discover the other HAVi devices appearing on the network. Furthermore a query can be made on this address to search for already existing HAVi devices on the network.

A mechanism similar to the SDD data is made available. This SDD data comprises a field indicating whether the HAVi device under scrutiny is connected to another cluster and the type of this other cluster (for example a IEEE1394 cluster).

Once each bridge has knowledge of the other bridges, it is possible to create a DCM representing a UPnP device in only bridge device. To choose which bridge creates the DCM/FCM, one of several variants may be used:
Choose the bridge whose IP address is (as an example of an unambiguous rule) just above that of the UPnP device, and which is able to handle this UPnP device, or
Define a complete protocol between the bridges to determine which one will provide a given DCM/FCM.
UPnP devices interact on a HAVi cluster

Mutual discovery is performed as follows:
(a) It is supposed that IP over IEEE 1394 is available. A UPnP bridge can discover other UPnP bridges via the SSDP protocol. A bridge associates the GUIDs of the other bridges with their IP addresses in a table. Since IP over IEEE 1394 is implemented, once the bridges are aware of each other, the bridges will behave as on any IP/UPnP cluster.

Another solution, but not preferred is to define a specific HAVi FCM or SDD data to signal that a device is a bridge toward another network.
(b) The synchronizations issues are the same as for HAVi, replacing the IP address by the GUID.

1. Method for connecting a HAVi cluster and an IP cluster using a bridge device, wherein it comprises the steps of:
discovering an IP device on the IP cluster,
creating a HAVi device identifier for the discovered device,
making the identifier available for reading by bridge aware HAVi software elements.

2. Method according to claim 1, wherein the step of creating the HAVi device identifier comprises a step of determining whether the discovered IP device is adapted to provide resources to a HAVi device, and in creating the identifier only in the affirmative.

3. Method according to claim 1, wherein the IP device is a UPnP device, further comprising the step of identifying UPnP services for the discovered UPnP device, and of providing, in the bridge device, a proxy HAVi device control module for the UPnP device and proxy HAVi functional component modules for the UPnP services, said modules being made available for communication with elements of the HAVi cluster.

4. Method according to claim 1, wherein the establishment of a stream connection between two devices initiated by an application on the HAVi cluster comprises the following steps:
calling of a Stream Manager by said application for requesting the establishment of the stream;
determination by the Stream Manager as to whether at least one of the two devices is on the IP cluster, and in the affirmative calling a software element of the bridge for establishing the connections for the stream set-up.

5. Method according to claim 4, wherein in the negative, the Stream Manager directly sets up the stream between two HAVi devices.

6. Method according to claim 1, further comprising the step of assembling HAVi device identifiers for a plurality of discovered devices in an identifier list register.

7. Method according to claim 1, wherein the HAVi device identifier is a GUID identifier derived from an 1P address of the discovered IP device.

8. Bridge device for connecting a HAVi cluster to an IP cluster, wherein it comprises:
means for discovering IP devices on the IP cluster;
means for generating a list of device identifiers for the discovered IP devices, said list being readable by a bridge aware HAVi software element.

9. Bridge device according to claim 8, further comprising means for receiving a function call from a HAVi stream manager software element for establishment of a stream between two devices of which at least one is connected to the IP cluster.

10. Method for connecting a HAVi cluster and an IP cluster using a bridge device, wherein it comprises the steps of:
discovering a HAVi device on the HAVi cluster,
creating an IP address for the discovered device,
making the IP address available for reading by bridge aware IP software elements.
